(19) United States
(12) Patent Application Publication
(10) Pub. No.: US 2007/0244831 A1
(43) Pub. Date: Oct. 18, 2007

(54) SYSTEM AND METHOD FOR SECURE ONLINE TRANSACTION

(76) Inventor: James Shaw-Han KUO, Piedmont, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/736,876

(22) Filed: Apr. 18, 2007

Related U.S. Application Data
(60) Provisional application No. 60/792,833, filed on Apr. 18, 2006.

(51) Int. Cl. H04L 9/00

(52) U.S. Cl. 705/67

(57) ABSTRACT

Methods and systems for secure electronic commerce (eCommerce) transactions having one or more trusted payment hosts where consumers/buyers can register credit card information and/or any payment card information and the corresponding secret keys for the credit card or payment card with the one or more payment hosts are provided. Embodiments of the invention include a method of engaging a purchase order in an online electronic transaction on the spot, where a seller posts and advertises at least one online electronic link embedded in a web-page or in an e-mail provided by a server.

### CROSS-REFERENCE TO RELATED APPLICATIONS

This application claims benefit of U.S. provisional patent application Ser. No. 60/792,833, filed Apr. 18, 2006, which is herein incorporated by reference.

### BACKGROUND OF THE INVENTION

1. Field of the Invention

Embodiments of the invention generally relate to electronic commerce (e-commerce) and systems and methods for processing secure online transaction for goods or services.

2. Description of the Related Art

As internet usage grows exponentially, transactions executed over the internet and online payments also increase dramatically. Electronic Commerce has grown more than 30% in dollar amount annually and has increased sales and profits for online merchants, large or small. Thanks to the prosperity of online comparison shopping sites and search engines, it is possible for online shoppers and buyers to find great products, goods, merchandises, and services through internet search at prices much lower than what can be found at neighborhood stores.

Furthermore, a merchant's website may not necessarily be the only internet presence for the merchant. Through various online advertising opportunities, an online merchant can have a broadly visible internet presence, for example, via web banner advertisements, via insert advertisements, via listings at comparison shopping sites or search engines, via promotional e-mails, etc. Even so, currently, online sale transactions are predominately completed only at the merchant's own website. That is, currently, all advertisements a merchant provided and paid for anywhere on the internet serve only one purpose: to direct internet traffic to the merchant's own website or home webpage. Thus, these online advertisements provide sales-lead only, which may not lead to completion of an online transaction.

Quite often, when a consumer clicks on online advertisements of a merchant, and is redirected back to the merchant's own website, the consumer can easily get lost on the merchant's website. For example, a potential sale may be frustrated if a person is unable to locate the shopping cart or unable to navigate through and finish checkout procedures, often lead to frustration and purchase abandonment. Additional registration and login procedures at the merchant's home website may also hinder an online transaction or purchase from being completed.

Any e-commerce internet presence, such as an online advertisement link in blogs, search engine sites, shopping comparison sites, or any shopping-link, any pop up advertisement, should ideally serve more than merely as a re-direct only or sales-lead only such that, when clicked, re-directs the consumer to the home website of the merchant. It lacks the ability to enable a consumer to complete a purchase transaction expeditiously on the spot where the advertisement appears.

Thus, there is no on-the-spot online transaction available. Overwhelming fraud concerns deter such convenience, even though it is clear that enabling such transactions will increase sales for merchants and provide efficient online shopping experiences for consumers. Consumer experiences can be positive only when there is mutual trust, however, the Internet is ultimately mutually anonymous communication channel. Secure processing of online payments is of utmost concern to consumers. A consumer's trust in a transaction, after authorizing a payment, can exist only after receiving satisfactory products or services, and when the confidential payment card information is not compromised or even disclosed to the seller. A seller's trust in a transaction can exist only after receiving monetary compensation, and preferably when there is no need for unnecessary and complicated additional accounting activities, such as opening, tracking and balancing new accounts, or tracking new account performance.

Online transactions often use digital credentials, such as payment card numbers, as a payment instrument that are supposed to be privileged and protected. However, since the internet is an open public network, sending payment information from consumers to merchants over the unprotected open network leaves this information wide open to compromise. Fraud is particularly prone to occur where buyers and sellers engage in online transactions anonymously to each other and often are making transactions with each other for the first time. Online fraudulence can come in many different forms. One of the most common frauds resulting from identity theft is the unauthorized use of stolen payment card numbers for online shopping in an e-commerce setting. Such threats for identity theft further deter the availability of on-the-spot online transactions.

As the foregoing discussion illustrating, online transactions must be secure, easy, fast, and convenient. At the same time, online transactions may need to be anonymous yet trusted in order for e-commerce to continue to grow.

Therefore, there is a need for improved systems and methods to prevent fraud, facilitate online on-the-spot business transactions, and to perform a variety of secure online transactions at any given web presence.

### SUMMARY OF THE INVENTION

Embodiments of the invention provide methods and systems for secure electronic commerce (eCommerce) transactions having one or more trusted payment hosts where consumers/buyers can register any credit card information and/or any payment card information and assign secret keys for the credit card, payment card and the corresponding payment account with the one or more payment hosts.

In one embodiment, a method of processing a purchase order in an online electronic transaction, where a seller posts at least one online electronic link provided by a server is provided. The method includes providing the online electronic link of the seller through the server for a buyer to invoke the online electronic link and place the purchase order with the seller, creating a data form with a payment authorization link for the purchase order from the online electronic link, and generating an orderID for the purchase order, generating through the payment authorization link a payment authorization request for the buyer to complete and to use to authorize payment of the purchase order by a pre-registered payment card of the buyer without disclosing a payment card number, wherein the buyer has pre-registered information related to the payment card in a pre-registered payment account with at least one host and has assigned secret keys for the pre-registered payment account with the at least one host. The method also includes sending the payment authorization request to the at least one host after the buyer fills out the secret keys for the pre-registered payment account on the payment authorization request, wherein the payment authorization request includes information on the purchase order, the orderID, and the secret keys for the pre-registered payment account. The method further includes verifying the payment authorization request by the at least one host, and sending the purchase order and the orderID to the seller. The method further includes sending a payment approval request having the purchase order and the orderID from the seller to the at least one host and requesting for payment approval of the purchase order from a payment card issuer of the pre-registered payment card through the at least one host, and matching the payment authorization request received from the buyer and the payment approval request received from the seller by the at least one host.

In another embodiment, a method is provided for processing a purchase order in an online electronic transaction, where an order management center posts at least one online electronic link provided by a server. The method includes providing the online electronic link by the order management center through the server for a buyer to invoke the online electronic link and place the purchase order with the order management center, creating a data form with a payment authorization link for the purchase order from the online electronic link, generating an orderID for the purchase order, and generating through the payment authorization link a payment authorization request for the buyer to complete and to use to authorize payment of the purchase order by a pre-registered payment card of the buyer without disclosing a payment card number, wherein the buyer has pre-registered information related to the payment card in a pre-registered payment account with at least one host and has assigned secret keys for the pre-registered payment account with the at least one host. The method further includes sending the payment authorization request to the at least one host after the buyer fills out the secret keys for the pre-registered payment account on the payment authorization request, wherein the payment authorization request includes information on the purchase order, the orderId, and the secret keys for the pre-registered payment account, verifying the payment authorization request by the at least one host, and sending the purchase order and the orderID to the order management center. The method also includes sending the purchase order and the orderID from the order management center to a seller which is selected based on predetermined criteria from a popularity of sellers who have registered with the order management center, sending a payment approval request having the purchase order and the orderID from the seller to the at least one host and requesting for payment approval of the purchase order from a payment card issuer of the pre-registered payment card through the at least one host, and matching the payment authorization request received from the buyer and the payment approval request received from the seller by the at least one host.

In another embodiment, a method of engaging a purchase order in an online electronic transaction, where a seller posts and advertises at least one online electronic link embedded in a web-page or an email provided by a server is provided and includes generating a transactionID by the at least one host, sending the purchase order and the transactionID from the at least one host to the seller, and sending a payment approval request having the purchase order and the transactionID from the seller to the at least one host and requesting for payment approval of the purchase order from a payment card issuer of the pre-registered payment card through the at least one host.

In one aspect, a payment authorization request received from a buyer and a payment approval request received from the seller are matched by at least one host over a time period determined by the at least one host to validate the purchase order by the at least one host.

In another aspect, the method also include detecting that the payment authorization request and payment approval request are not matched within the time period, and terminating the purchase order by the at least one host by expiring the payment approval request.

In another aspect, the method further includes recovering by the at least one host the secret keys sent by the buyer for the payment authorization request having the purchase order and orderID which is exactly the same as the purchase order and orderID in a payment approval request, hashing by the at least one host with the secret keys for the pre-registered account to obtain a payment card number for paying the purchase order with the orderID. In still another aspect, the method includes sending by the at least one host a payment authorization approval request to the buyer's payment card issuer, with the payment card number, through a payment gateway or payment clearing network, and receiving by the at least one host an approval of the payment authorization approval request from the buyer's payment card issuer. The method also includes sending a payment completion message by the at least one host to the seller to release the delivery of the purchase order from the seller to the buyer. The payment completion message includes shipping address and contact information for the buyer.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram of an exemplary system according to one embodiment of the invention.

FIG. 2 illustrates an exemplary prompt and exemplary electronic links according to one embodiment of the invention.

FIG. 3 illustrates a flow diagram of an exemplary method according to one embodiment of the invention.

FIG. 4A illustrates a block diagram of another exemplary system according to one embodiment of the invention.

FIG. 4B illustrates a flow diagram of another exemplary method according to one embodiment of the invention.

FIG. 5A illustrates an exemplary electronic link according to one embodiment of the invention.

FIG. 5B illustrates another exemplary electronic link according to one embodiment of the invention.

FIG. 5C illustrates another exemplary electronic link according to one embodiment of the invention.

FIG. 5D illustrates another exemplary electronic link according to one embodiment of the invention.

FIG. 6 illustrates an interactive exemplary prompt and exemplary electronic links according to one embodiment of the invention.

FIG. 7 illustrates a flow diagram of another exemplary method according to one embodiment of the invention.

### DETAILED DESCRIPTION

Embodiments of the invention generally provide a secure, distributed, user friendly, non-repudiation online transaction model which alleviates consumer fraud and merchant fraud. In one embodiment, online transaction systems and methods are provided to facilitate instant and on-the-spot transactions among unrestricted participants over any open, unsecured, wide area communication network, such as the internet. According to one embodiment of the invention, a method and system for instant and secure online transactions are provided to facilitate transaction on the spot anywhere a seller or merchant has an online presence through an online electronic link or an online advertisement, anywhere on the internet. In another embodiment, methods and systems are provided for secure electronic commerce (eCommerce) transactions having one or more trusted payment hosts where consumers/buyers can register or pre-register any credit card and/or any payment card information and assign secret keys for the credit card or payment card and assign secret keys for the corresponding registered payment account with the one or more payment hosts.

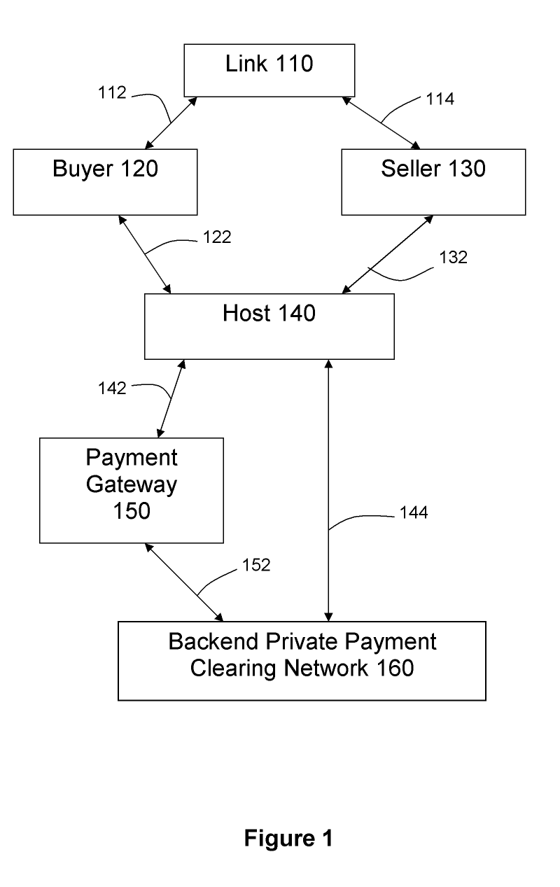

FIG. 1 illustrates an exemplary electronic commerce system having a host 140, a seller 130, a buyer 120, and a link 110 where the buyer 120 can purchase products or services from the seller 130 through the link 110 on-the-spot and the buyer 120 can authorize payments through the host 140 to provide secure online transaction over a network. The host 140, the seller 130, the buyer 120, and the link 110 can be interconnected through the network, such as the open, unsecured internet, or an electronic web system, and can all be capable of communicating with each other over the network.

The link 110 can be an advertisement provided by the seller 130 through advertisement publishing servers, advertisement hosting servers, the seller's own web servers, comparison shopping web servers, and other servers or web sites. The link 110 is provided to facilitate secure on-the-spot transactions between buyers and sellers, such as online transactions away from the seller's home website. Transaction oriented online links can prevent click fraud. In one embodiment, a merchant only pays fees for transactions that are completed through the link.

The link 110 may be, for example, an advertisement, an online advertisement or an electronic link, such as an online advertisement link in blogs, search engine sites, shopping comparison sites, or any shopping-link, pop up advertisement, etc. The link 110 can be provided in a web-page, in an e-mail, or in any online electronic presence by a shopping server or the seller 130, such as a merchant, a company, etc., through advertisement publishing servers or advertisement hosting servers, among others. For example, the link 110 may be an online electronic link appearing in a web-page, including but not limited to, a static banner, a dynamic banner, a static block insert, a dynamic block insert, an icon, and inline text, an insert in a web page, a text anchor listing alongside a search result, etc. In one embodiment, the link 110 serves as more than a redirect or sales-lead only. The link 110 may further include means for shopping on-the-spot, such as clicks or buttons for placing an order, submitting a purchase order, or for research a product or a service, in addition to the sales-lead or redirect.

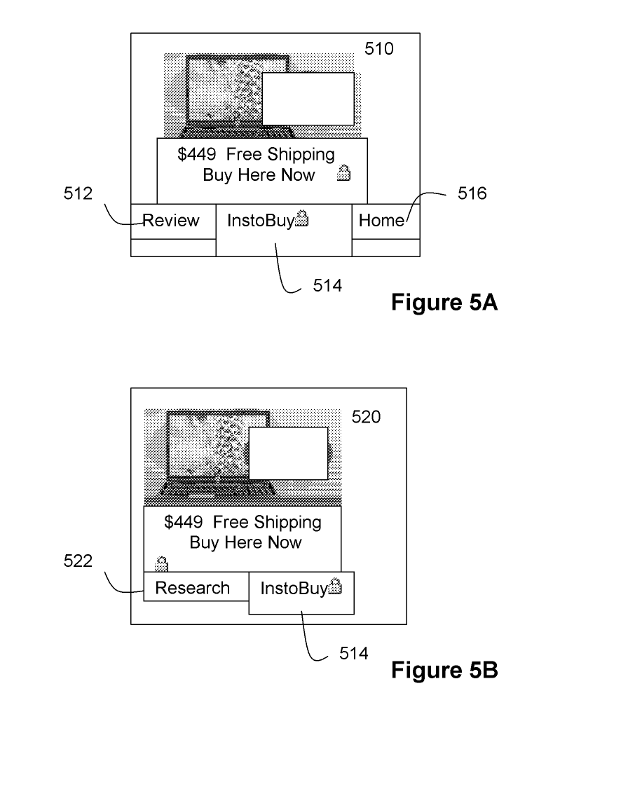

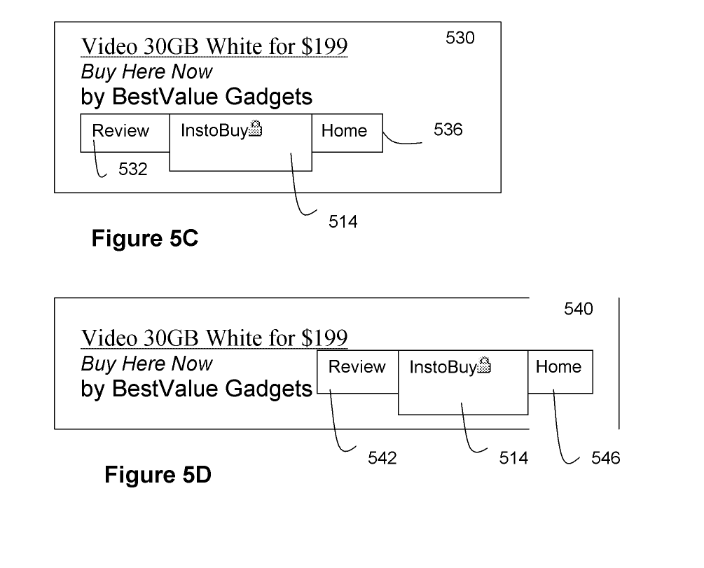

The link 110 may appear in various forms of display, such as in textual displays which are often present in many search marketing advertisements, in multimedia displays, or any other display formats. In one embodiment, the link 110 may show a sign to indicate secure instant transaction, such as a sign, a symbol, e.g., a lock or text to indicate secure transaction, purchase, buying, shopping, etc, mechanisms that are available for the link 110. Examples of the link 110 are shown in FIGS. 5A-5D. The link 110 may be displayed as an online electronic advertisement link and can be tagged with scripts and/or various URI's, such as destination URI (Uniform Resource Identifier), destination URL (Uniform Resource Locator) where the buyer's browser can land or retrieve when the buyer 120 invokes the link 110. In one embodiment, the link 110 may display a merchant's name, a merchant's brand name, and/or merchant's e-mail address, among others. In another embodiment, the advertisement that shown as the link 110, may not display a merchant's name, a merchant's brand name or a merchant's e-mail address, such as some advertisements shown along side search results, shown in comparison shopping websites or other websites.

In one embodiment, the electronic commerce system may include a trusted payment card host, as exemplified as the host 140, to facilitate authorizating the use of a pre-registered payment card of the buyer 120 for the payment of an order for a service or a product advertised using the link 110. The payment card of the buyer 120 can be any kinds of a payment card, including, but not limited to, a credit card, a gift card, an ATM card, an online reward card, an online coupon, etc.

The host 140 may be presented as a secure computer server or servers where buyers can register and set up a pre-registered payment account or accounts. The host 140 provides and stores a repository of pre-registered and encrypted payment card information that associates with a pre-registered payment account or accounts for multiple buyers 120. In an alternative embodiment, the host 140 can also accept payment card information entered contemporaneously during online shopping if no payment card information for the buyer 120 is already pre-registered with the host 140.

The buyer 120 can register their payment cards with a single host or various hosts of their choices, and set up secret keys for authenticating and authorizing payment by pre-registered payment cards through the host 140. Secret keys for a payment card are used to authorize the use of the payment card of the buyer 120 for the payment of any purchase, and allow the host 140 to recover the payment card information for processing payment authorization approval request. Similarly, secret keys for the pre-registered payment account are used to authendicate the buyer 120 to the host 140 and authorize the buyer with privileges and access to the pre-registered payment account. One example of a host, such as a payment card host, for secure online transaction is also described in U.S. Pat. No. 6,847,953, filed Feb. 4, 2000, which is incorporated by reference herein.

In general, the host 140 communicates over the network through the servers of the host 140; the seller 130 communicates over the network through the servers of the seller 130; the buyer 120 communicates over the network using computer browser applications running on any computer systems, any wireless devices, mobile devices, or any device browsers of the buyer 120; and the link 110 is presented online through its hosting server, or advertisement publishing server, and communicates passively when invoked, according to tagged scripts or URI, or through the advertisement hosting server or advertisement publishing servers, or other service or supporting servers for the link 110.

As shown in FIG. 1, at communication 112, anywhere on the web, the buyer 120 may spot a link 110 that is provided to sell products or services online. The buyer 120 can click on the link 110, and enters an order of the products or services on-the-spot.

Through communication 112, the buyer 120 can initiate the on-the-spot online transaction by entering the order at the link 110. In one embodiment, the information regarding the order, as well as the products or services being purchased, can be included in the URL header to transmit order data from communication 112 to communication 122. Together with the order, the buyer 120 may specify the host 140 of his or her choice, e.g., a host where the buyer 120 has pre-registered his or her payment card information. If no host is specified, a default host can be selected, and the buyer 120 is prompted to register at the default host, while entering necessary payment information for the order. If there is only a single host available for a given buyer, seller, or transaction, then the order does not need to include or specify the host.

Once the buyer 120 initiate an order, an orderID is generated and assigned to the order. The orderID may include information including, but not limited to, data of the host, data of the seller, etc. In another embodiment, the orderID can be an unique ID (identification) for one-time use only. As an example, the orderID may include a sequence of alphanumerical characters, and can be a seller's e-mail address, a seller's userID, a random number, a randomly picked multi-digit number, a randomly picked password, a chosen password, a data structure, a structure of name-value-pairs, etc. In one embodiment, the orderID can be generated by the buyer 120, by a browser script, by a browser plug-in, by a hosting server which hosts the advertisement, an advertisement publishing server, a host, or a payment host, etc.

In another embodiment, a buyer can pre-register one or more payment cards with one or more hosts such that the information of the one or more payment cards need not be disclosed or subject to theft or compromise when the buyer is shopping online. The buyer can pre-register payment card information with a host and obtain a payment account with the host. As a result, account number, account userID, account passwords, secrete keys for the payment card, and payment card number and other personal information, etc., of the buyer can be pre-registered with the host. One or more secret keys for the payment cards can be assigned, chosen, or designed by the buyer or by the payment host server, such that the payment cards can be used for paying for online transaction without the need to disclose any payment card numbers over an open or hostile network. Through the communication 122 with the host 140, the buyer 120 may authorize payment of an order with an orderID by a payment card of the buyer through the host 140, which handles the payment card for the buyer, using the order, the orderID and the secret keys.

In one embodiment, upon placing the order, and once the orderID is generated, the buyer 120 is prompted a payment authorization request to authorize payment for the order. For example, the buyer 120 may be prompted to login into a server of the host, where the buyer has pre-registered one or more payment cards in a payment account of the host, and to authorize using the payment card to pay for the order of the service or products offered by the link 110. Login into

As an example, the prompt for the payment authorization request can be a login panel with a “cancel” button and a “new user” HTML anchor. The prompt can also include a summary of the order with the orderID. For buyers pre-registered with the host 140, after reviewing the order summary to be correct, the buyer may login through the login panel provided by the host 140 using secret keys for the pre-registered payment account, such as login credentials, account ID, user ID, one or more passwords, etc.

To make the login process more secure, passwords comprised of alphanumerical characters, words combinations, numbers, and/or an one-time-password can be used. For example, an one-time password synchronized between a device or token used by the buyer 120 and the login server of the host 140 can be used during the login process. After login into the pre-registered payment account with the host using the secret keys for the pre-registered payment account, the buyer 120 may proceed to enter information for the payment authorization request, selecting a pre-registered payment card to pay for the order with the orderID, and authorize the payment by supplying secret keys for the pre-registered payment card. If the buyer 120 supplies inaccurate secret keys for authorizing the pre-registered payment card, the host may deny the payment authorization request and terminate the transaction. Furthermore, each pre-registered payment card can be tagged with a name meaningful to the buyer 120, making it easier for the buyer 120, when selecting a payment card to pay for an order.

Without pre-registration of payment cards with the host 140, there is a potential risk for consumer fraud, due to stolen payment cards, and identity theft. However, trading more sales with higher risk, if the seller is willing to accept a buyer without pre-registered payment cards, a non-registered buyer can click on a “new user” anchor when prompted to complete a payment authorization request and to fill in all the necessary payment card information live on a new payment form, and send the payment information as a request for payment authorization with the order and orderID to the host 140. Based on the payment card information and other additional personal information, the host 140 may offer to register non-registered buyers and continue with the online transaction. In any case, the buyer 120 may be provided an option to click on a “cancel” button at any stage during the transaction to terminate the transaction.

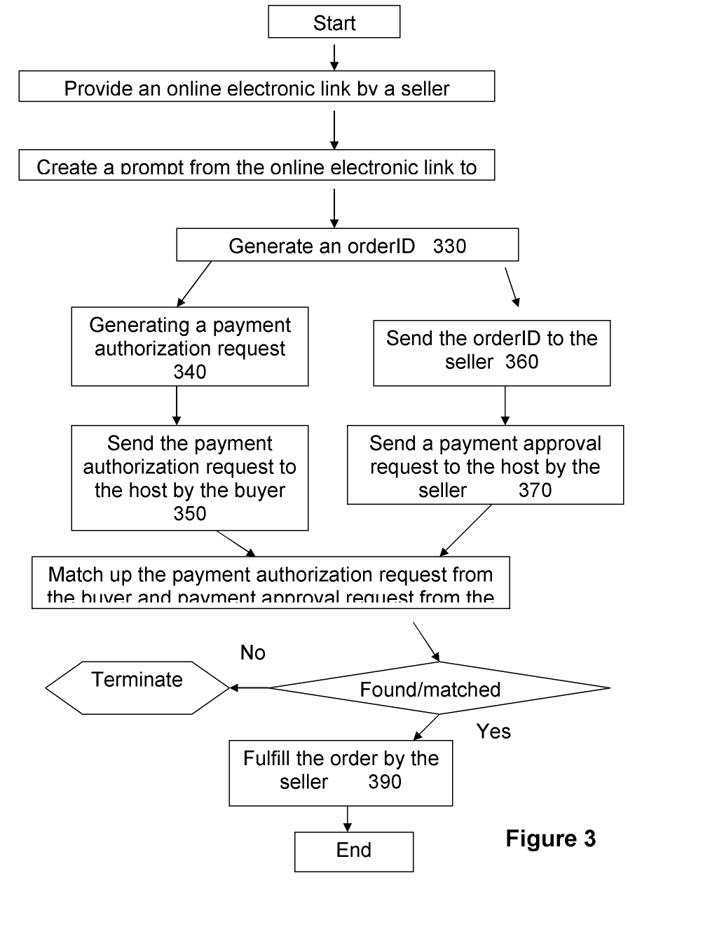

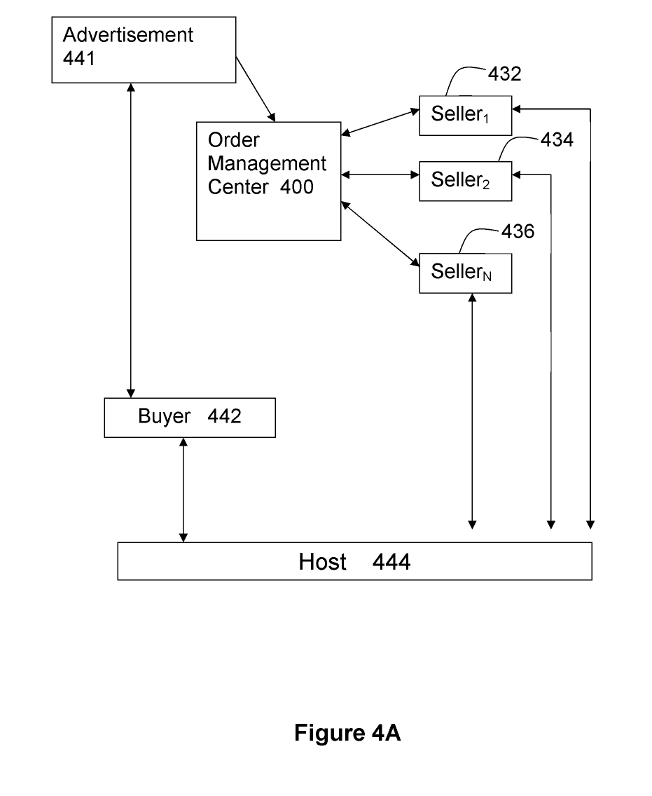

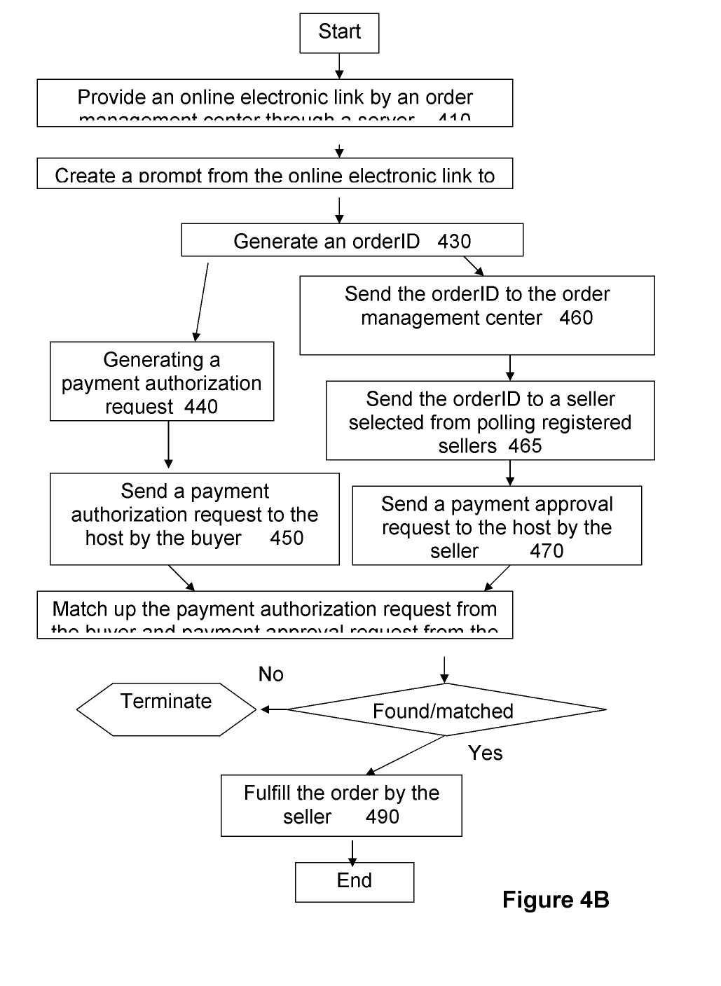

When the transaction is successfully authorized and upon capturing the order, the link 110 communicates 114 the order and the orderID to the merchant's merchant server 130, as illustrated in more detailed flowchart in FIG. 3, or may communicate the order and orderID to an order management center 400, which in turn, communicates the order and orderID to the merchant servers of the selected seller or sellers, as further illustrated in detail in FIG. 4A. In one embodiment, the seller 130 may check available inventory upon receiving the order, confirm the availability of ordered items, optionally place status trace or place hold on the ordered items for future delivery.

If the order cannot be fulfilled, an order-not-available message can be generated by the seller 130 to inform the buyer 120 that the transaction is terminated or temporarily incomplete. The order-not-available message can be sent to the buyer 120 through e-mail, or other means. The order-not-available message can also be sent to the host 140, such as by sending an “order-not-available” message with orderID from the seller 130 to the host 140, for the host 140 to match the orderID and notify the buyer 120 that the order cannot be fulfilled. If the ordered items are available, in all or in part, the seller 130 may generate a communication 132 with the host 140.

Through the communication 132, the seller 130 requests for payment approval through the host 140, with the same order and orderID. The communication 132 may include a payment approval request that is generated by the seller and sent to the host 140. The payment approval request may contain information including, but not limited to, the order, the orderID, merchant's financial institution, merchant ID, merchant address, or any merchant data required by a payment clearing network 160, and/or participating financial institutions to ensure that the seller can and is legitimate to receive payment of the transaction. However, the payment approval request does not include the buyer's payment information or any payment card number.

In one embodiment, the host 140 can match the information on the order and the orderID of the communication 122 and the communication 132 from the buyer and from the seller, respectively, and recovers the secret keys. Information of the order and orderID and other information are included in the payment approval request from the seller 130 and the payment authorization request from the buyer 120 and can be searched and matched. Only the host 140, where the buyer 120 has pre-registered the payment card information, holds secure hash values of payment card data that the buyer 120 is using to pay for the order.

In one embodiment, matching is performed by the host within a time period. For example, upon receiving the payment authorization request from the buyer 120 and/or the payment approval request from the seller, the host 140 will try to find the match of the payment authorization request and the payment approval request by searching a pool of payment authorization requests and a pool of payment approval requests which are received within a time period around the time that the payment approval request or the payment authorization request is received. The length of this time period can be determined by the host 140 to reduce potential fraud, unduly delayed of the processing, and/or contamination (stolen order or orderID) of the payment authorization request and/or the payment approval request. In other words, this time period or time window may serve to expire the payment approval request due to the inability to find a match for a corresponding payment authorization request, or, vice versa.

If the host 140 cannot find the payment authorization request with matched information of a payment approval request, within the pre-set time period, the payment approval request is rejected, and a “payment-request-timeout” message with the order and orderID is constructed and sent back to the seller 130 and the buyer 120. The transaction is thus terminated.

The server of the seller 130 is a computer server or servers that a merchant uses to process purchase orders and other tasks. As stated, the link 110 is a web presence of a merchant or a seller for promoting its products and services to serve as an extension of the merchant's storefront. The communication 114 between the link 110 and the server of the seller 130 can be any communication, such as through scripts, XML tags, servlets, or URI tags, etc. The link 110 can also communicate to the seller 130 and/or the server of the seller 130 through the advertisement hosting/publishing server that hosts or publishes the link 110.

The advertisement hosting/publishing servers can be, for example, advertisement service engines, such as listing engines, search engines, comparison shopping listing engines, comparison shopping search engines, portal shopping engines, shopping carts, wish-list carts, advertisement service engines, advertisement listing engines, fulfillment distribution engines, etc. The buyer 120 may be a consumer who utilizes a consumer device or a web browser to participate in an online on-the-spot transaction.

The communications 112, 114, 122, 132 and any messages delivered via the internet, between the buyer 120 and the link 110, between the link 110 and a seller 130, between the buyer 120 and the host 140, between the seller 130 and the host 140, can be encrypted via secure sockets layer (SSL) or wireless transport layer security (WTLS) connections. In an active eCommerce environment, there can be many hosts 140, many merchant servers/many sellers 130, many advertisements/many links 110, and of course, many consumers/buyers 120, interconnected and distributed over the internet.

The host 140 hashes with the secret keys for the pre-registered payment account to discover any pre-registered information regarding a payment card of the buyer 120 in the payment account. In general, each of the secret keys for the payment account for authentication and authorization can be any secret keys pre-set by the host 140 or pre-registered by the buyer 120 with the host 140 and includes, but is not limited to, userIDs, passwords, pre-registered payment card account userIDs and passwords, passphrases, one-time passwords, pre-set answers to pre-set questions, challenge and response mechanisms, public keys, PKI certificates, digital certificates, among others. For example, the secret keys for a pre-registered payment account can be, for example, an userID and one or more passwords pre-registered with the host 140 by the buyer 120. To further enhance the security, the secret keys the pre-registered payment account can further include PIN or password assigned for pre-registered payment cards registered in the pre-registered payment account, so that in the event that the secret keys, such as the userID and the password for the payment account that the buyer has registered with the host is compromised, the payment cards are still safe.

To further secure payment card credentials, such as a payment card number, in addition to encryption, a payment card number can be hashed into multiple parts, each arranged into random bits, before it is encrypted and stored in the host 140. And only with the secret keys specific for the payment card and in the owner's possession can re-hash the multiple parts to recover the payment card number.

In one embodiment, to secure further against fraudulent websites that impersonate a host, the buyer can set-up personalizations to personalize privileged web pages where buyer is requested to enter secret keys for authorization of payment to the orders, such as those web pages where the buyer would enter PIN or passwords which are pre-registered secret keys for the payment cards.

Personalization of privileged web pages can be such that on those privileged web pages, secret personal messages are displayed upon posted to the buyer's browser. The secret personal messages are designed, selected and pre-registered with the host at the time when the payment cards are registered and the secret keys for the payment cards are assigned. The secret personal messages can be textual like a greeting sentence, graphical like a drawing, or multimedia like a video.

Personalization of privileged web pages can also be such that when those privileged web pages are displayed and posted unto the buyer's browser, secret web page background images are displayed, where the secret web page background images are designed and pre-selected at the host at the time when the payment cards are registered and the secret keys for the payment cards are assigned. The secret web page background images can be various design patterns easily recognized and remembered by the buyer, such as maple leaves or checker board, and in varieties of colors, such as in green or in red.

In one embodiment, after the buyer has placed an order at a link 110, and is prompted and login to the pre-registered payment account at the host server 140, and goes to a privileged web page where the buyer is required to enter secret keys for the payment cards to authorize payment for the order, but does not see the pre-selected or pre-registered personalization on the privileged web page, the buyer would stop right away, knowing that the payment host server the buyer just login is not the host server where the buyer has registered his or her payment cards and payment account. The userID and password for the payment account may have been compromised, but the secret keys for authorizing payment with the registered payment cards are safe, and the buyer may then reset the userID and password for the payment account with the real host 140, to limit (or prevent) any financial losses.

The secret keys for authenticating and authorizing a pre-registered payment card or payment account can be the same or be different. The secret keys can be changed by the buyer 120 at the request of the host 140, or by the buyer self 120 for any reason. The secret keys also can be changed at a preset periodical time, or, at a time when deemed necessary. In one embodiment, for security reasons, the secret keys are not stored in an unprotected form. If any secret key is stored at the host 140, the secret key should be securely one-way hashed. In one embodiment, only the hash value of a secret key is stored at the host 140. An example of a securely hashed value of a secret key that need to be stored at the host 140 is the login account userID and password.

If the host 140 finds a payment authorization request with same order, orderID (and possibly other order information) as a payment approval request, within the set time period, the host 140 may use the secret keys from the buyer 120 to recover and hash out the buyer's payment card data, such as a payment card number associated with the buyer or the buyer's pre-registered payment account, construct a formal payment authorization approval request on behalf of the seller 130, incorporating the payment card information of the buyer 120, and send the payment authorization approval request along with the payment card number to the buyer's payment card issuer for approval through an Internet Payment Gateway, or a payment card clearing network 160.

In one embodiment, the buyer's payment card data, such as the payment card number, etc., is discovered by hashing with the secret keys for the payment account by the host 140. In another embodiment, where the buyer assigned secret keys for the payment account and also assigned secret keys for the payment card when the buyer pre-registered the payment card and the payment account with the host, the buyer's payment card data is discovered by hashing with secret keys for the payment card after the secret keys for the payment account are verified by the host 140. In one aspect, the secret keys for the payment card can be a PIN, or one or more passwords. In the event that the payment authorization approval request is denied, a message “payment denied” is sent to the buyer 120 and the seller 130, and the transaction is terminated.

The host 140 can process a payment authorization approval request and communicate indirectly or directly with a backend payment clearing network for authorizing payment for the order of the products or services offered by the link 110. The payment authorization approval request may include, but not limited to, the purchase order, orderID, and the payment card number, etc. For example, the host can communicate with a payment gateway 150 through a communication 142 and then with the backend payment clearing network 160 through a communication 152, or with the backend private payment clearing network 160 directly through a communication 144. All messages sending and passing through the communications 142, 144, 152 are SSL or WTLS channel encrypted, and all messages received are decrypted by recipients.

The host 140 can notify the seller 130 of any response from the payment card issuer approving or disapproving the payment approval request. If the payment authorization approval request is successfully approved by the private payment clearing network 160 or the payment gateway 150, the seller 130 may fulfill the order. In addition, the seller may send for payment capturing through the host 140. If the buyer's payment card issuer denies the payment request, the host 140 may notify the buyer 120 and notify the seller 130 of the denial response from the buyer's payment card issuer, and the transaction is then terminated.

Upon receiving an approval response to the payment authorization approval request from the buyer's payment card issuer via the payment gateway 150 or the private payment clearing network 160, the host 140 may generate a message that includes the order, the orderId, and the response from the buyer's payment card issuer and send the message to the seller 130 and the buyer 120. The message sent from the host 140 to the seller 130 may also include consumer's shipping and contact information (such as e-mail address, shipping address, phone number, etc.) for the seller 130 to fulfill the order, and the seller 130 may send an e-mail to the consumer 120 concerning the order details and fulfillment. The host 140 and the seller 130 may store the transaction records for future reconciliation.

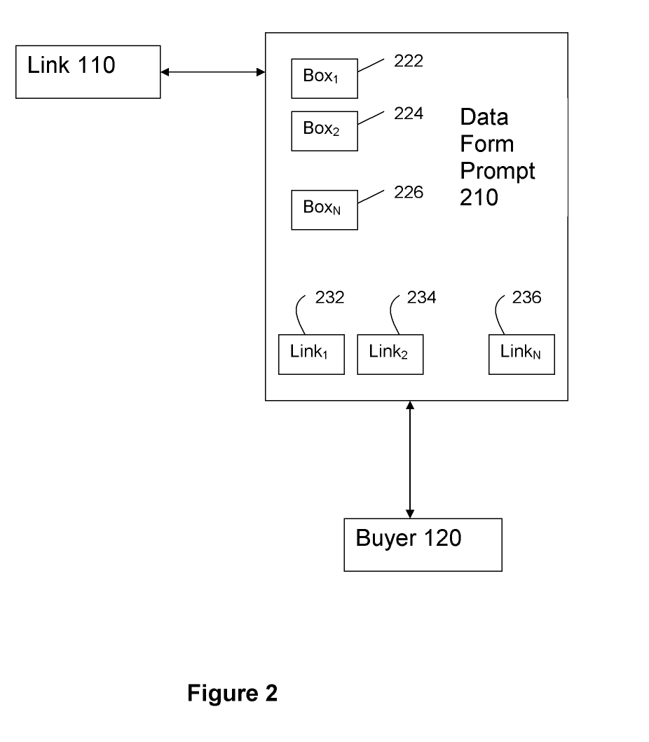

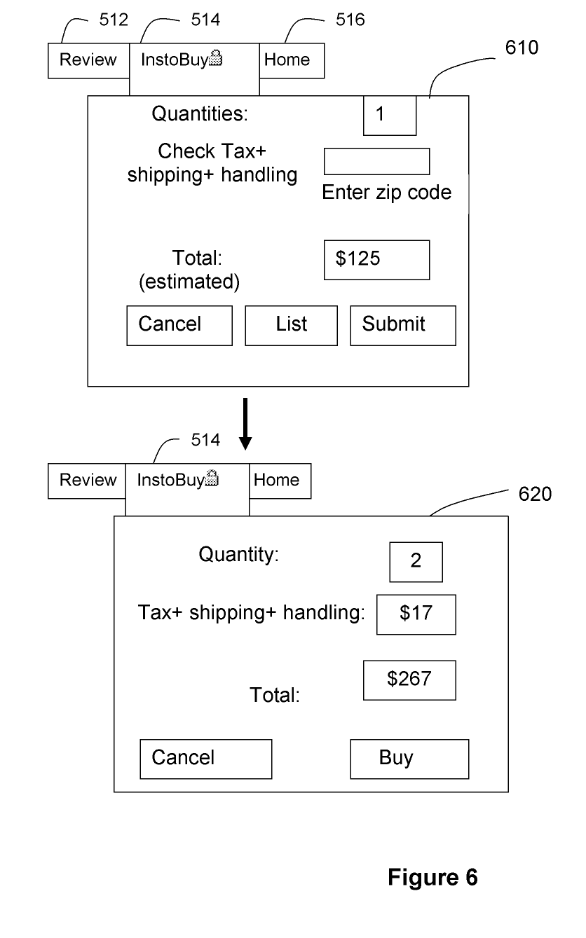

FIG. 2 further illustrates an example of the communication 112 between the link 110 and the buyer 120 when the buyer initiates an on-the-spot transaction. In one embodiment, when the buyer 120 clicks on the link 110 (or a secure transaction sign at the link), the buyer is prompted with a data form 210 to complete. The data form 210 may include boxes 222, 224, 226 for the buyer to fill in and electronic links 232, 234, 236 for the buyer to select. Examples of the boxes 222, 224, 226 can include, but are not limited to, the names of the products or services, quantities of the products or services, shipping zip-codes, tax, coupon codes, total cost, etc. as also illustrated in examples in FIG. 6.

Examples of the electronic links 232, 234, 236 can be links to cancel the transaction, and payment authorization links to submit or place a purchase order. The electronic links 232, 234, 236 can include, but are not limited to, buttons, links, or other graphical elements, such as “cancel”, “submit”, “buy”, “place order”, “put-in-list”, “OK”, “confirm”, “authorize payment”, etc. The buyer 120 enters the order by filling out the boxes 222, 224, 226 and clicking on the selected buttons or electronic links 232, 234, 236 to submit, cancel, or place the order. In one embodiment, the buyer is prompted to fill in information for a payment authorization request upon clicking payment authorization links 232, 234, 236 to confirm the purchase order on the data form prompt 210 The payment authorization links 232, 234, 236 such as “submit” button, “buy” button, “confirm” buttons, etc., are invoked by the buyer on the order entry data form for authorizing payment for the order. In one aspect, the payment authorization request is prompted to the buyer as a payment account login page of the host 140 to authorize the payment for the order.

FIG. 3 shows one example of a method for a buyer to initiate an on-the-spot e-commerce transaction, where a seller posts and advertises at least one online electronic link embedded in a web-page, e-mail, or other electronic communications. The method may include, at step 310, providing an online electronic link on a server, such as a link displayed in a web-page or e-mail. In general, a buyer, when surfing the internet, may encounter the link, a sign, an advertisement, and the like, which is published or posted by an advertisement server and may originally be provided by a seller to sell products or services. The advertisement, as represented as an internet electronic link, or other type of clicks, links, tags, is usually an insert in a web page that the consumer is viewing. The advertisement may also be a link listed alongside a web page of a search result when a consumer or buyer is searching for a product or a service online through a search engine or a listing engine. The consumer can conduct a search on a search engine such as the Google@, Yahoo®, or MSN®, or searches engines through a shopping comparison listing engine, e.g., Shopping.com, Become.com, etc.

At step 320, an entry form is created from the online electronic link to the buyer. When the buyer clicks on the online electronic link, sign, or advertisement, the buyer is prompted the order entry data form (e.g., a data form 210) for the buyer to purchase for the service or product and place an order as part of performing the on-the-spot transaction. Examples of the data form 210 are shown in FIG. 2 and FIG. 6. When the order entry data form is filled out by the buyer, the buyer may need to select the host where the buyer has pre-registered payment cards and payment account, among a number of available hosts. In a single host system, the buyer does not have a choice of the host.

At step 330, an orderID, such as an unique one-time ID, is generated and assigned to the order. The orderID can be generated in a number of ways, such as by a server that hosts the link 110, by a publisher server that publishes the link 110, by the host 140, via scripts embedded in the link 110, and/or any browser plug-ins. The orderID can be a simple random number, or simply the seller's name, seller's userID, seller's e-mail address, with or without timestamp or nonce, or any combinations thereof.

Once the buyer completes the order entry data form and submits it by clicking on a payment authorization link, a payment authorization request is generated for the buyer to enter. The buyer can then enter secret keys in the payment authorization request form to authorize payment for the order. The content of the payment authorization request may include information on the order, orderID, the secret keys, and other information related to the products or services advertised in the link 110.

At step 340, a payment authorization request is generated by the host 140 and posted to the buyer's browser for the buyer to fill out information thereon. The buyer can then enter secret keys for the payment account in the payment authorization request to authorize payment for the order. The content of the payment authorization request may include information on the purchase order, orderID, the secret keys for the payment account, and other information related to the products or services advertised in the online electronic link.

At step 350, the payment authorization request is filled out and sent to the host by the buyer to authorize the payment for the order with a payment card pre-registered with the host.

At step 360, the orderID is attached to the order, and the order together with the orderID is sent to the seller. The order and orderID can be sent from the server which published the online electronic link to the seller to notify the seller the buyer's order of the products or services that the seller is offering in the online electronic link advertisement. In addition, the order can also be sent through the scripts embedded at the online electronic link, which advertises the products or services of the seller, to communicate to a server of the merchant/seller with the same unique one-time orderID. In one embodiment, a purchase order inquiry may also be sent to the seller together with the orderID. The seller checks inventory and the availability of the products or the services and requests for payment approval through the payment host with the order and orderID.

At step 370, a payment approval request is prepared by the seller and sent to the host. The content of the payment approval request may include description and information for the order, the orderID, merchant's financial institution, merchant ID, merchant address, or any merchant data required by payment clearing network, and/or participating financial institutions to ensure that the seller can and is legitimate to receive payment of the transaction.

At step 380, the host matches the payment authorization request obtained from the buyer and the payment approval request obtained from the seller to recover the secret keys. For example, the order, the orderID, and/or other information from the payment authorization request received from the buyer and the payment approval request received from the seller can be matched by the host. If a match of the order and the orderID on the payment authorization request and the payment approval request are found, the payment card host hashes payment card information (e.g., payment card number, etc.) with the secret keys received from the payment authorization request. If a match is not found, the payment card host can terminate the order.

At step 390, once a match is found, the host may request approval of the payment of the order and inform the seller to fulfill the order. Payment of the order can be designed to be at the time the order is filled, or before the products, goods, merchandises are shipped or arrived, or the services are rendered. The host can request the approval of the payment for the order by the buyer's payment card through a payment gateway or through a backend payment clearing network. For example, the host can process the payment authorization approval request and send the request to the issuer of the payment card that is hashed out with the secrete keys specified in the payment authorization request obtained from the buyer and obtain approval of the payment by the payment card from the issuer of the payment card. Once the payment is approved by the payment card issuer through the payment gateway or through the backend payment clearing network, the host can notify the seller of the payment approval response. If the payment approval request is successful, the seller fulfills the order, and sends for payment capturing through the host.

Accordingly, embodiments of the invention includes a method of engaging a purchase order in an online electronic transaction, where a seller posts and advertises at least one online electronic link provided by a server is provided. In operation, the method includes providing the online electronic link by the seller through the server for a buyer to invoke the online electronic link and place the purchase order with the seller, creating a data form with a payment authorization link for the purchase order from the online electronic link of the server to the buyer. The online electronic link provided by the server may be embedded in a web-page, in an e-mail, in an online advertisement, in an online document, among others.

The purchase order may include an order for online advertised products, online advertised services, online advertised goods, and combinations thereof, etc. When the buyer invokes the online electronic link and places the purchase order, the buyer can have the option of selecting the host of his or her choice. The seller may be, for example, an online merchant, an order management center, a comparison shopping center, an order aggregator, an order reseller, among other.

The method further include generating an orderID for the purchase order, and generating through the payment authorization link a payment authorization request for the buyer to fill in and authorize payment of the purchase order by a payment card without disclosing a payment card number, wherein the buyer has pre-registered information of the payment card in a pre-registered payment account with at least one host and has assigned secret keys for the pre-registered payment account with the at least one host. The orderID generated for the purchase order may include information on the seller, such as a sellerID, the seller's name, the seller's e-mail address, the seller's destination URI (Uniform Resource Identifier), the seller's destination URL (Uniform Resource Locator), URI of the seller's order processing server, and combinations thereof.

The payment authorization request is sent from the buyer to the at least one host after the buyer fills out the information for the secret keys of the pre-registered payment account on the payment authorization request, wherein the payment authorization request comprises information on the purchase order, the orderID, and the secret keys for the pre-registered payment account. The secret keys for the pre-registered payment account may include at least one key for authentication and at least another key for authorization. The secret keys for the pre-registered payment account may also include an userID for the pre-registered payment account and one or more passwords for the pre-registered payment account. The payment authorization request is verified by the host by verifying the secret keys for the pre-registered payment account.

Once the buyer placed the order at the advertisement link, the purchase order and the orderID are also sent to the seller. The seller check order available and send a payment approval request having the purchase order and the orderID to the at least one host and requesting for payment approval of the purchase order from the buyer's payment card issuer through the at least one host. The at least one host can match up the payment authorization request received from the buyer and the payment approval request received from the seller.

As an example, when the buyer has pre-assigned one or more passwords for a payment card with the host, the host can further verify the payment authorization request by verifying the one or more passwords for the payment card. As another example, the one or more passwords for the payment card can be secured from phishing and other payment card theft or ID theft by personalization of privileged web pages of the buyer. In one embodiment of the invention, the one or more passwords for the payment card are provided by the buyer to the host in a privileged web page of the buyer. As one example, a privileged web page of the buyer can be personalized by the buyer with the host so that when the buyer is required to enter the one or more passwords for the payment card in a privileged web page of the buyer to authorize payment for an order, the privileged web page is personalized and posted to the buyer's browser. When the host is verifying the payment authorization request, the host may need to verify the secret keys for the pre-registered payment account and to verify the one or more passwords for the pre-registered payment cards in the privileged web page of the buyer. As another example, the personalization of the privileged web page of the buyer can be accomplished by selecting a background for the privileged web page of the buyer by the buyer with the host.

Alternatively, personalization of the privileged web page of the buyer can be accomplished by registering one or more secret personalization messages by the buyer with the host. The one or more secret personalization messages may include, but are not limited to, textual messages, graphical messages, multimedia messages, and combinations thereof.

In one aspect of the invention, the payment authorization request and the payment approval request received by the host are matched over a time period determined by the host. In the event that the payment authorization request and payment approval request are not matched within the time period, the purchase order is terminated by the host by expiring the payment approval request. The host may send a purchase order termination message to the seller and send a purchase order termination message to the buyer.

In another aspect, the payment authorization request and the payment approval request received by the host can find match over a time period determined by the host. In the event that the payment authorization request and payment approval request are matched within the time period, the host may continue to recover the secret keys sent by the buyer from the payment authorization request having the orderID which is exactly the same as the_orderID in the matched payment approval request. The host may also continue to hash with the secret keys to obtain the payment card number for paying the purchase order with the orderID and send a payment authorization approval request to the buyer's payment card issuer, with said payment card number, through a payment gateway, and receiving an approval of the payment authorization approval request from the buyer's payment card issuer.

Once the payment authorization approval request is approved by the payment card issuer to pay for the purchase order by the payment card of the buyer, the host may send a payment completion message to the seller to release the delivery of the purchase order from the seller to the buyer. The payment completion message may include shipping address and contact information of the buyer. In addition, the host may send an order completion message to the buyer to notify the completion of the payment of the purchase order, construct a receipt for the purchase order, and send the receipt to the buyer.

FIG. 4A-4B show a block diagram and a flow chart for another example of a method for a consumer to engage in a purchase order in an online electronic transaction, where one or more merchants or sellers can fulfill orders but do not directly provide any advertisements or online electronic links as the advertisements. The advertisement links can be provided by an order management center 400. As illustrated in FIG. 4A and FIG. 4B, a number of sellers 432, 434, 436 can fulfills orders received from a 3^{rd} party institution, such as the order management center 400, which directly provide advertisements but themselves cannot fulfill the order as advertised. Examples of the order management center 400 include, but are not limited to, wholesaler of products and services, sales channel aggregators, comparison shopping web-sites, among others.

In one embodiment, the sellers 432, 434, 436 sign up or register at the order management centers 400 and enter into business agreements, so that the sellers can acquire and fulfill orders that the order management centers 400 receives. When a buyer 442 initiates an on-the-spot transaction by clicking a sign or an advertisement 441 that is provided by the order management center 400 and published by an advertisement server, the buyer 442 clicks on the sign or the advertisement 441, and the buyer 442 is presented with an order entry data form to enter order online on-the-spot.

At step 410, an online electronic link, such as an online advertisement, is provided by an order management center through a server. A consumer or a buyer, when surfing the internet, may encounter the online electronic link and decide to browse and/or purchase the products or services offered by the online advertisement by clicking on the online electronic link.

At step 420, a data form is created from the online electronic link and presented to the buyer for completion. For example, an order entry data form may be prompted for the buyer to enter an order online on the spot. Examples of the data form prompt 210 are shown in FIG. 2 and FIG. 6. Once the data form is filled out by the buyer 442, per FIG. 4A, the buyer 442 may have the choice to select a seller that the buyer desires among a number of sellers, such as the sellers 432, 434, 436, which have registered with the order management center 400. Alternatively, the order management center 400 can select a seller among a number of sellers according to some criteria, for example, criteria specified by the buyer, such as locations of the sellers, prices of the products or service, tax benefits, among others. Still alternatively, the order management center 400 can select a seller or sellers to send the order to, by polling the sellers 432, 434, 436, who have registered with the order management center 400, with seller-selection criteria which has been pre-determined or selected on the spot. The selection criteria can be based on, for example, but not limited to, whether the seller can fulfill the order now, time lapse required to fulfill the order, pricing, certification, ranking or compliance to ordinances or regulations, the choice of the buyer, etc.

At step 430, an orderID, such as an unique one-time ID, is generated and assigned to the order. At step 440, a payment authorization request is generated by the host and posted to the buyer's browser, for the buyer to fill out information on the payment authorization request to authorize payment for the order. Completing the order entry data and submitting the order entry data form, per FIG. 4A, the buyer 442 is presented a payment authorization request form to authorize for the payment of the order through the host 444. The buyer 442 enters secret keys in the payment authorization request form to authorize payment for the order offered by the advertisement 441, and sends the payment authorization request to the host 444.

At step 450, the payment authorization request is sent to the host 444 by the buyer 442 to authorize the payment of the order with a payment card that is pre-registered with the host 444.

At step 460, the orderID is attached to the order, and the order together with the orderID is sent to the order management center 400. The advertisement 441 provided by the order management center 400 communicates to the order processing servers of the order management center 400 using the order and the orderID. In one embodiment, the orderID generated at step 430 is an unique one-time only orderID specific for the one-time order.

At step 465, the purchase order and the orderID are sent from the order management center to the seller selected from the registered sellers. The selected seller can then send a request for payment approval through the host 444, with the order and the orderID. When an order cannot be fulfilled is apparent during the time that the order management center 400 conducting the selection of the registered sellers for fulfillment, an order-not-available message can be sent to the buyer 442 via e-mail or other online communication channels. Alternatively, the order management center 400 may send an “order-not-available” message with the orderID to the host 444, the host matches the orderID and notify the buyer 442 that the order cannot be fulfilled, thus terminates the transaction.

At step 470, a payment approval request for this order is prepared by the seller and sent to the host together with the orderID, when the ordered items are available, in all or in part. The content of the payment approval request may include description and information for the order, the orderID, merchant's financial institution, merchant ID, merchant address, or any merchant data, among others, that are required by payment clearing network, and/or participating financial institutions to ensure that the seller can and is legitimate to receive payment of the transaction.

At step 480, the host matches information from the payment authorization request obtained from the buyer and the payment approval request obtained from the seller to recover the secret keys. For example, the host can identify any payment authorization request and any payment approval request which have the same orderID. If a match of the information, such as the order and/or the orderID, etc., on the payment authorization request and the payment approval request are found, the host recovers the secret keys for the pre-registered payment account sent by the buyer and hashes payment card information of the buyer (e.g., a payment card number, etc.) with the secret keys. If a match is not found, the payment card host can terminate the order.

At step 490, once a match is found, the host may request approval of the payment of the order from the payment card issuer and inform the seller to fulfill the order. The host can request the approval of the payment of the order using the hashed payment card information of the buyer through a payment gateway or through a backend private payment clearing network. Once the payment is approved by the issuer of the payment card through the payment gateway or through the backend payment clearing network, the host can notify the seller of the approval response. If the payment approval request is successful, the seller fulfills the order, and sends for payment capturing through the host. The seller may also notify the order management center 400 concerning whether the order is processed, either fulfilled or terminated.

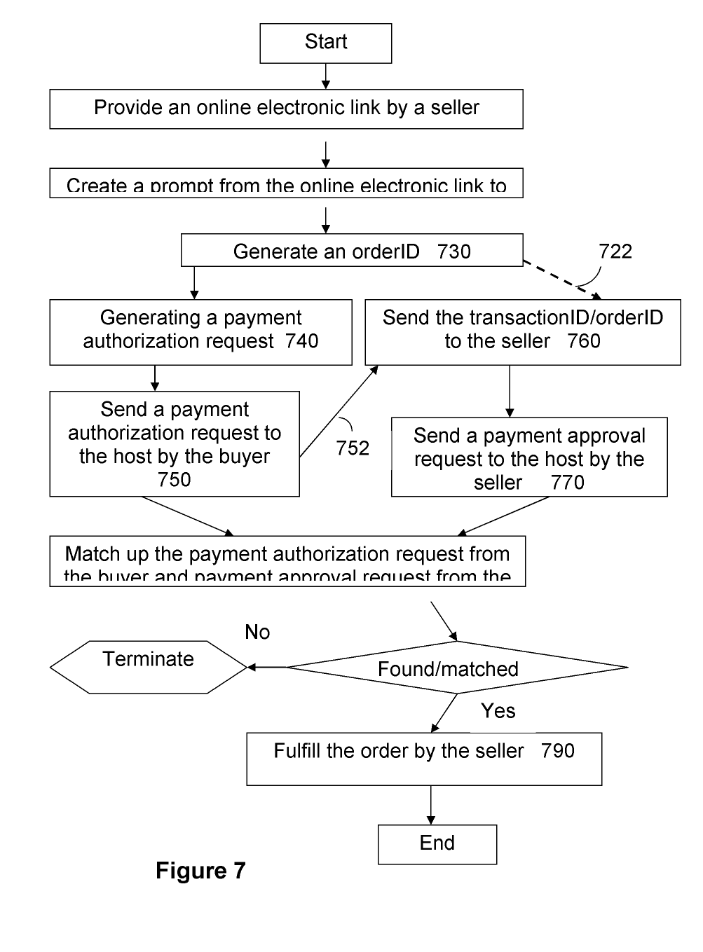

In another embodiment, where, at the time, data of the orders placed on-the-spot at the advertisement does not reach the merchant servers that process orders, due to reasons such as system set-up, network-ability problems, or certain mobile network restrictions, nonetheless, the transactions as described herein can be securely carried out as usual as illustrated in FIG. 7. For example, when a seller or a server of a seller can not be reached, data of the seller can be included in the orderID generated.

FIG. 7 shows another example of a method for engaging a purchase order in an online electronic transaction, where a seller posts and advertises at least one online electronic link, but the online electronic link cannot communicate the order data to the seller. The method may include, at step 710, providing an online electronic link. At step 720, the buyer clicks on the online electronic link and, in response, a data form is presented to the buyer. The buyer is prompted to complete the data form and order online on-the-spot. Examples of the data form are shown in FIG. 2 and FIG. 6.

At step 730, an orderID is generated and assigned to the order. In one embodiment, the orderID can be an unique one-time ID, a data structure, or a structure of XML name-value-pairs, etc. The orderID generated may include additional information including, but not limited to, data of the seller, a sellerID, a seller's name, a seller's e-mail address, URI of a seller's order processing server(s), timestamp, nonce, etc. Once the data form is filled out and submitted by the buyer as part of initiating the on-the-spot transaction, a payment authorization request is generated at step 740. The buyer can then enter secret keys in the payment authorization request to authorize payment for the order.

At step 750, the payment authorization request is sent to the host by the buyer to authorize the payment for the order with a payment card pre-registered with the host. The buyer enters secret keys in the payment authorization request form to authorize payment for the purchase order and send the payment authorization request to the host. The payment authorization request generally includes the purchase order, orderID, and the secret keys.

As shown in FIG. 7, the seller's advertisement or the online electronic link provided by the seller through a server, may not communicate successfully or directly, as shown as a dashed arrow 722, to the merchant/seller's order processing server. Instead, at step 752, the host, after receiving and verifying the payment authorization request sent from the buyer, can generate a transactionID and the host can communicate to the seller regarding the order that the buyer has placed at the online electronic link.

At step 760, the host can send information about the order that the buyer has placed and the transactionID to the seller and communicate with the seller in the event that the seller did not receive the order and orderID. The transactionID may contain information including the orderID. In one embodiment, the transaction ID sent from the host to the seller may be identical to the orderId. Once the seller receives the order and the transactionID or the orderID for the products or services that the online electronic link offered, the seller can check inventory to make sure that the products or services for this order are available.

At step 770, the seller can request payment approval through the host by sending a payment approval request to the host with order and the transactionID or the orderID when the seller is ready to fulfill the order.

At step 780, the host matches the payment authorization request from the buyer and the payment approval request from the seller. If a match is found, the payment host recovers the secret keys for the pre-registered payment account from the matched payment authorization request and hashes payment card information of the buyer with the secret keys for the pre-registered payment account. The host then processes the payment authorization approval request with the payment card information, such as processing with a hashed payment card number, through payment gateway or through backend payment clearing network, and notifies the seller of the response from the payment card issuer for the payment approval request. At step 790, if the payment approval request is successful, the seller fulfills the order, and sends for payment capturing through the host.

FIGS. 5A-5D show examples of the link 110. As shown in FIGS. 5A-5D, electronic links 510, 520, 530, 540 can be pictures, multimedia advertisements, or textual advertisement with embedded on-the-spot shopping buttons 514. The electronic links 510, 520, 530, 540, as online advertisements can appear in many forms and shapes, such as banners, links, images, and textual hyperlink anchors, etc., as those skilled in the art can easily understand. The electronic link may or may not include a merchant's information, a merchant's name, a merchant's brand name, or a merchant's e-mail address. Accordingly, the online advertisement of these electronic links 510, 520, 530, 540 may serve as virtual store-front in order to facilitate speedy on-the-spot online transactions.

The on-the-spot shopping buttons 514 may be represented as submit, buy, or InstoBuy (as exemplarily shown in FIGS. 5A-5D) buttons, and may bear a secure sign, such as a lock icon, [symbol] , as shown in FIGS. 5A-5D. The on-the-spot shopping buttons 514 can be shown as always, or can be hidden and only be shown once the buyers click on the link 110, or when the buyer moves the mouse cursor over the link 110. The design of the on-the-spot shopping buttons 514 can also be a textual link, or even just the link without a visible button. In one embodiment, the link 110, that is the electronic links 510, 520, 530, 540, themselves can also serve as the default on-the-spot shopping buttons 514 to facilitate secure on-the-spot transaction of an online order.

In another embodiment, the electronic links 510, 520, 530, 540 may also include additional buttons, links, scripts, or clicks, such as research 522, review 512, 532, 542, home 516, 536, 546, etc. for additional options, such as for going to other web-pages or web sites. The labels or the “review”, “research”, “InstoBuy”, “home” buttons, e.g., research 522, review 512, review 532, home 516, home 536, etc. can be changed without loss of generality, so that the labeled names of each button can reflect the actual functional behavior of each button, such as change “review” to “research”, change “home” to “re-direct”, change “instoBuy” to “instant buy”, etc. are suitable changes without altering the system behavior. It is also easy for the skilled in the art to see that the buttons can easily be replace with textual hyperlink anchors with similar labels. In one embodiment, when a consumer clicks on the “review” button, the advertisement can display an informational web page that relates to the product or service the link 110 or the advertisement is offering. The informational web page can also contain links to other relevant web resources. Clicking on the “home” button can be used to re-direct the consumer to the home page of the server of the seller posting the advertisement. The design of the on-the-spot shopping buttons 514 on the advertisement links can vary and can be a 3-button strip (as shown in FIGS. 5A, 5C, and 5D), 2-button strip (as shown in FIG. 5B), a 2-button strip with “instant buy” and “home” option, or a 1-button with “instant buy” option, or no visible button with the advertisement link itself functions as the default shopping button 514.

FIG. 6 shows examples of data forms 610, 620, which are presented to a buyer when the buyer decides to place an order and clicks on the advertisement electronic link, or clicks on the shopping buttons 514 of an electronic link. The buyer can enter information on the data forms 610, 620 to place order on the spot. The data form prompts 610, 620 include data fields or boxes to be filled-in, including, but not limited to, quantity, tax, shipping & handling, total, etc., and with buttons or links such as “cancel”, “authorize payment”, “submit”, “preview order”, “put in list”, “buy” and/or “place order”. The confirmation-to-purchase button or link, such as “authorize payment” or “buy”, may serve as payment authorization link that upon buyer's invocation, will bring out the payment authorization request for the buyer to fill in and send to the host, to authorize payment for the order placed. To find out fees on tax, shipping and handling charges, the buyer may enter the zip-code of the shipping address into the data form prompts 610 for a calculation of the fees. In addition to data field to be filled out by the buyer, portion of the data fields of the data form prompt can be pre-set and/or automatically updated, for example, when the quantity is changed from 1 to 2, the data form prompt 610 can be changed to data form prompts 620.

Accordingly, one benefit of the eCommerce transaction process and method as described herein is that a secure process for online transactions can be taken place in real time on-the-spot at any online merchant presence that is away from a merchant's home website. It brings a great efficiency to digital eCommerce that has not been explored today. In this transaction model, even though the payment card is processed as usual and in real time, the buyer does not need to enter payment card number online, and no payment card number is presented to the seller or is transported over an open or hostile network, such as the internet, reducing a potential buyer's fear of shopping online. In case that a payment card number has been stolen, it is rendered useless when going shopping online within this transaction model. Further, as payment card numbers do not travel online, eavesdropping of the payment card numbers may be prevented.

Another benefit to consumers using the online transaction process as described herein is that a merchant or a seller does not handle consumer's payment card number, thus alleviating potential for payment card abuse by a fraudulent merchant or by merchant employees. At the same time, a merchant in the online advertisement is not subject to click fraud. An additional benefit is that the on-the-spot transaction process described herein can be deployed over any communication protocols or communication networks, wired, wireless or mobile wireless. It has a further benefit to be complementary to existing payment card network systems or payment gateways that handle authorization and settlement of payment card payments.

In addition, the online transaction process as described herein can be applied to a transaction involving ordered items provided from multiple sellers and/or paid by multiple payment cards hosted at multiple trusted payment card hosts. The principles of the online transaction method as described herein can equally be applied and implemented. Multiple messages to and from the buyer can be encrypted and queued over SSL or WTLS encryption channels. Furthermore, when a payment card account pay out must be approved by more than one party, then, each approval authority can set up a set of secret keys associated with that payment card account, to exercise the due power of authorization when authenticated. Authentication and authorization are verified upon submission of the secret keys. Thus, the online transaction process, model, method as described herein can be applied equally well to multiple levels of authorization requirements.

Although several preferred embodiments which incorporate the teachings of the present invention have been shown and described in detail, those skilled in the art can readily devise many other varied embodiments that still incorporate these teachings. In addition, while the foregoing is directed to embodiments of the present invention, other and further embodiments of the invention may be devised without departing from the basic scope thereof, and the scope thereof is determined by the claims that follow.

1. A method of processing a purchase order in an online electronic transaction, where a seller posts at least one online electronic link provided by a server, comprising:
providing the online electronic link of the seller through the server for a buyer to invoke the online electronic link and place the purchase order with the seller;
creating a data form with a payment authorization link for the purchase order from the online electronic link;
generating an orderID for the purchase order;
generating through the payment authorization link a payment authorization request for the buyer to complete and to use to authorize payment of the purchase order by a pre-registered payment card of the buyer without disclosing a payment card number, wherein the buyer has pre-registered information related to the payment card in a pre-registered payment account with at least one host and has assigned secret keys for the pre-registered payment account with the at least one host;
sending the payment authorization request to the at least one host after the buyer fills out the secret keys for the pre-registered payment account on the payment authorization request, wherein the payment authorization request includes information on the purchase order, the orderID, and the secret keys for the pre-registered payment account;
verifying the payment authorization request by the at least one host;
sending the purchase order and the orderID to the seller; and
sending a payment approval request having the purchase order and the orderID from the seller to the at least one host and requesting for payment approval of the purchase order from a payment card issuer of the pre-registered payment card through the at least one host; and
matching the payment authorization request received from the buyer and the payment approval request received from the seller by the at least one host.

2. The method of claim 1, wherein the purchase order comprises an order selected from the group consisting of online advertised products, online advertised service, online advertised goods, and combinations thereof.

3. The method of claim 1, wherein the orderID generated for the purchase order further comprises information on the seller selected from the group consisting of a sellerID, the seller's name, the seller's e-mail address, the seller's destination URI (Uniform Resource Identifier), the seller's destination URL (Uniform Resource Locator), URI of the seller's order processing server, and combinations thereof.

4. The method of claim 1, further comprising selecting the at least one host by the buyer.

5. The method of claim 1, wherein the secret keys for the pre-registered payment account comprise at least a first key for authentication and at least a second key for authorization.

6. The method of claim 1, wherein the secret keys for the pre-registered payment account comprises an userID for the pre-registered payment account and one or more passwords for the pre-registered payment account.

7. The method of claim 1, wherein the verifying the payment authorization request by the at least one host comprises verifying the secret keys for the pre-registered payment account by the at least one host.

8. The method of claim 7, further comprising detecting that the payment authorization request and payment approval request are not matched within a time period, and terminating the purchase order by the host by expiring the payment approval request, wherein the time period is determined by the at least one host.

9. The method of claim 8, further comprising:
sending a purchase order termination message by the at least one host to the seller; and
sending a purchase order termination message by the at least one host to the buyer.

10. The method of claim 7, further comprising detecting that the payment authorization request and payment approval request are matched within a time period, and validating the purchase order by the at least one host, wherein the time period is determined by the at least one host.

11. The method of claim 10, further comprising:
sending by the at least one host a payment authorization approval request to the buyer's payment card issuer, with the payment card number, through a payment gateway; and
receiving by the at least one host an approval of the payment authorization approval request from the buyer's payment card issuer.

12. The method of claim 11, further comprising sending a payment completion message by the at least one host to the seller.

13. The method of claim 12, wherein the payment completion message comprises the shipping address and contact information for the buyer.

14. The method of claim 11, further comprising:
sending an order completion message by the at least one host to the buyer;
generating a receipt for the purchase order, and
sending the receipt to the buyer.

15. The method of claim 7, further comprising:
recovering by the at least one host the secret keys for the pre-registered payment account sent by the buyer; and
hashing by the at least one host with the secrete keys for the pre-registered payment account to obtain the payment card number of the pre-registered payment card for paying the purchase order.

16. The method of claim 7, wherein one or more passwords are assigned for the pre-registered payment card by the buyer with the at least one host and wherein the verifying the payment authorization request by the at least one host further comprises verifying the one or more passwords for the pre-registered payment card by the at least one host.

17. The method of claim 16, further comprising:
hashing by the at least one host with the one or more passwords assigned for the pre-registered payment card to obtain the payment card number for paying the purchase order.

18. The method of claim 16, further comprising designing by the buyer personalization for one or more privileged web pages of the buyer with the at least one host, wherein verifying the payment authorization request by the at least one host comprises verifying the secret keys for the pre-registered payment account and verifying the one or more passwords for the pre-registered payment card in the one or more privileged web pages of the buyer.

19. The method of claim 18, wherein the designing the personalization for the one or more privileged web pages of the buyer comprises assigning a background for the one or more privileged web pages of the buyer with the at least one host.

20. The method of claim 18, wherein the designing the personalization for the one or more privileged web pages of the buyer comprises registering one or more secret personalization messages by the buyer with the at least one host.

21. The method of claim 20, wherein the one or more secret personalization messages are selected from the group consisting of textual messages, graphical messages, multimedia messages, and combinations thereof.

22. The method of claim 1, wherein the seller is selected from the group consisting of online merchants, order management centers, comparison shopping centers, order aggregators, order resellers, and combinations thereof.

23. The method of claim 1, wherein the online electronic link is embedded in a format selected from the group consisting of web-pages, e-mails, online advertisements, online documents, and combinations thereof.

24. A method of processing a purchase order in an online electronic transaction, where an order management center posts at least one online electronic link provided by a server, comprising:
providing the online electronic link by the order management center through the server for a buyer to invoke the online electronic link and place the purchase order with the order management center;
creating a data form with a payment authorization link for the purchase order from the online electronic link;
generating an orderID for the purchase order;
generating through the payment authorization link a payment authorization request for the buyer to complete and to use to authorize payment of the purchase order by a pre-registered payment card of the buyer without disclosing a payment card number, wherein the buyer has pre-registered information related to the payment card in a pre-registered payment account with at least one host and has assigned secret keys for the pre-registered payment account with the at least one host;
sending the payment authorization request to the at least one host after the buyer fills out the secret keys for the pre-registered payment account on the payment authorization request, wherein the payment authorization request includes information on the purchase order, the orderID, and the secret keys for the pre-registered payment account;
verifying the payment authorization request by the at least one host;
sending the purchase order and the orderID to the order management center;
sending the purchase order and the orderID from the order management center to a seller which is selected based on predetermined criteria from a plurality of sellers who have registered with the order management center;
sending a payment approval request having the purchase order and the orderID from the seller to the at least one host and requesting for payment approval of the purchase order from a payment card issuer of the pre-registered payment card through the at least one host; and
matching the payment authorization request received from the buyer and the payment approval request received from the seller by the at least one host.

25. The method of claim 24, wherein the purchase order comprises an order selected from the group consisting of online advertised products, online advertised service, online advertised goods, and combinations thereof.

26. The method of claim 24, wherein the orderID generated for the purchase order further comprises information on the order management center.

27. The method of claim 24, further comprising selecting the at least one host by the buyer.

28. The method of claim 24, wherein the secret keys for the pre-registered payment account comprise at least a first key for authentication and at least a second key for authorization.

29. The method of claim 24, wherein the secret keys for the pre-registered payment account comprises an userID for the pre-registered payment account and one or more passwords for the pre-registered payment account.

30. The method of claim 24, wherein the verifying the payment authorization request by the at least one host comprises verifying the secret keys for the pre-registered payment account by the at least one host.

31. The method of claim 30, further comprising detecting that the payment authorization request and payment approval request are not matched within a time period, and terminating the purchase order by the at least one host by expiring the payment approval request, wherein the time period is determined by the at least one host.

32. The method of claim 31, further comprising:
sending a purchase order termination message by the at least one host to the seller; and
sending a purchase order termination message by the at least one host to the buyer.

33. The method of claim 30, further comprising detecting that the payment authorization request and payment approval request are matched within a time period, and validating the purchase order by the at least one host, wherein the time period is determined by the at least one host.

34. The method of claim 33, further comprising:
sending by the at least one host a payment authorization approval request to the buyer's payment card issuer, with the payment card number, through a payment gateway; and
receiving by the at least one host an approval of the payment authorization approval request from the buyer's payment card issuer.

35. The method of claim 34, further comprising sending a payment completion message by the at least one host to the seller to release the delivery of the purchase order from the seller to the buyer.

36. The method of claim 35, wherein the payment completion message comprises the shipping address and contact information for the buyer.

37. The method of claim 34, further comprising:
sending an order completion message by the at least one host to the buyer;
generating a receipt for the purchase order, and
sending the receipt to the buyer.

38. The method of claim 30, further comprising:
recovering by the at least one host the secret keys for the pre-registered payment account sent by the buyer; and
hashing by the at least one host with the secrete keys for the pre-registered payment account to obtain the payment card number of the pre-registered payment card for paying the purchase order.

39. The method of claim 30, wherein one or more passwords are assigned for the pre-registered payment card by the buyer with the at least one host and wherein the verifying the payment authorization request by the at least one host further comprises verifying the one or more passwords for the payment card by the at least one host.

40. The method of claim 39, further comprising:
hashing by the at least one host with the one or more passwords assigned for the pre-registered payment card to obtain the payment card number for paying the purchase order.

41. The method of claim 24, wherein the online electronic link is embedded in a format selected from the group consisting of web-pages, e-mails, online advertisements, online documents, and combinations thereof.

42. A method of processing a purchase order in an online electronic transaction, where a seller posts at least one online electronic link provided by a server, comprising:
providing the online electronic link of the seller through the server for a buyer to invoke the online electronic link and place the purchase order with the seller;
creating a data form with a payment authorization link for the purchase order from the online electronic link;
generating an orderID for the purchase order;
generating through the payment authorization link a payment authorization request for the buyer to complete and to use to authorize payment of the purchase order by a pre-registered payment card without disclosing a payment card number, wherein the buyer has pre-registered information related to the payment card in a pre-registered payment account with at least one host and has assigned secret keys for the pre-registered payment account with the at least one host;
sending the payment authorization request to the at least one host after the buyer fills out the secret keys for the pre-registered payment account on the payment authorization request, wherein the payment authorization request includes information on the purchase order, the orderID, and the secret keys for the pre-registered payment account;
verifying the payment authorization request by the at least one host;
generating a transactionID by the at least one host;
sending the purchase order and the transactionID from the at least one host to the seller;
sending a payment approval request having the purchase order and the transactionID from the seller to the at least one host and requesting for payment approval of the purchase order from a payment card issuer of the pre-registered payment card through the at least one host; and
matching the payment authorization request received from the buyer and the payment approval request received from the seller by the at least one host over a time period determined by the at least one host to validate the purchase order by the at least one host.

43. The method of claim 42, wherein the orderID generated for the purchase order further comprises information on the seller selected from the group consisting of a sellerId, the seller's name, the seller's e-mail address, the seller's destination URI (Uniform Resource Identifier), the seller's destination URL (Uniform Resource Locator), URI of the seller's order processing server, and combinations thereof.

44. The method of claim 42, wherein the transactionID further comprises the orderID for the purchase order.

45. The method of claim 42, wherein the seller is selected from the group consisting of online merchants, order management centers, comparison shopping centers, order aggregators, order resellers, and combinations thereof.
